(19) United States
(12) Patent Application Publication
(10) Pub. No.: US 2014/0365687 A1
(43) Pub. Date: Dec. 11, 2014

(54) Display Apparatus and USB Host

(71) Applicant: Kabushiki Kaisha Toshiba, Tokyo (JP)

(72) Inventors: Toshihiro Morohoshi, Kawasaki-shi, kanagawa-ken (JP); Yuichi Inoue, Tokyo (JP)

(21) Appl. No.: 13/910,759

(22) Filed: Jun. 5, 2013

(51) Int. Cl. G06F 3/14

(52) U.S. Cl. CPC G06F 3/1407
USPC 710/4

(57) ABSTRACT

According to one embodiment, a display have a USB host configured to divide object data, and to transmit the divided object data and a unique ID allocated to the object data through a USB cable, a USB device configured to receive the object data from the USB host through the USB cable, and a display unit configured to display an image corresponding to the object data.

### FIELD

Embodiments described herein relate generally to a display and USB HOST.

### BACKGROUND

As resolution of a display becomes higher, image data to be displayed becomes larger. If the size of image data is large, a long time is required to transfer or process data to display an image, and, as a result, there is a problem that a long time is required until the image is displayed. Particularly when data is transferred through a USB interface, this problem is remarkable because a transfer rate of the USB interface is slower compared to other interfaces.

### BRIEF DESCRIPTION OF THE DRAWINGS

FIG. 1 is a block diagram illustrating a schematic configuration of a display device.

FIG. 2 is a sequence diagram illustrating a processing operation of the display device according to the first embodiment.

FIG. 3 is a sequence diagram illustrating a processing operation of a display device according to the second embodiment.

FIG. 4 is a sequence diagram illustrating a processing operation of a display device according to the third embodiment.

FIGS. 5A and 5B are diagrams illustrating an example of processing of the display device in the picture display mode.

### DETAILED DESCRIPTION

Embodiments of the present invention will be specifically described below with reference to the drawings.

### First Embodiment

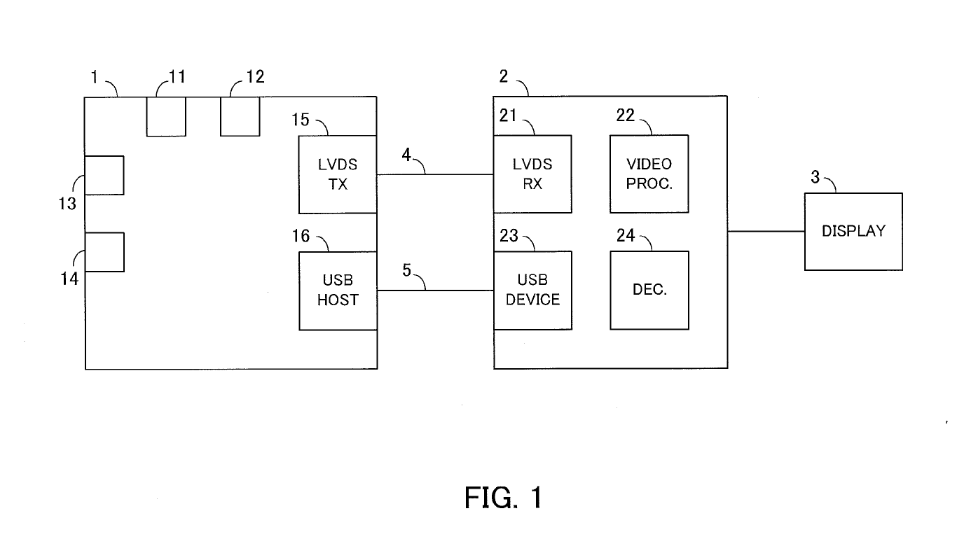

FIG. 1 is a block diagram illustrating a schematic configuration of a display device. The display device has a main board 1, a video processing device 2, and a display unit 3.

The main board 1 has a HDMI (High Definition Multimedia Interface) input terminal 11, a tuner input terminal 12, a card slot 13, a USB (Universal Serial Bus) terminal 14, a LVDS (Low Voltage Differential Signaling) transmitter (LVDS TX) 15 and a USB host 16.

A video signal from an optical disk playback device and the like is inputted to the HDMI input terminal 11 through an HDMI cable (not illustrated). A video signal from a tuner is inputted to the tuner input terminal 12. The LVDS transmitter 15 transmits these video signals to the video processing device 2 through the LVDS cable 4.

Into the card slot 13, a recording medium, such as an SD card (registered trademark), is inserted. The USB terminal 14 is connected with a recording medium, such as a hard disk or an optical disk, through a USB cable (not illustrated). Object data recorded in these recording media is read. The USB host 16 transmits the read object data to the video processing device 2 through the USB cable 5.

An example will be described, in the present embodiment, where one or more items of picture data are recorded as object data in these recording media. Picture data is compressed according to a predetermined format such as JPEG (registered trademark). Further, the picture data is transmitted to the video processing device 2 in a compressed state through the USB cable 5.

The video processing device 2 has a LVDS receiver 21, a video processing unit (VIDEO PROC.) 22, a USB device 23 and a decoder (a processor, DEC) 24.

The LVDS receiver 21 receives the video signal transmitted from the main board 1 through the LVDS cable 4. The video processing unit 22 performs various types of video processing, such as high resolution conversion processing and stereoscopic display processing, on the video signal. A video image corresponding to a processed video image is displayed on the display unit 3.

The USB device 23 receives the picture data transmitted from the main board 1 through the USB cable 5. The decoder 24 decodes the compressed picture data. The image corresponding to the decoded picture data is displayed on the display unit 3. Note that, the USB device 23 has only an end point of a bulk transfer and does not have an end point of an interrupt transfer.

In the display device in FIG. 1, picture data is transferred between the main board 1 and the video processing device 2 through the USB cable 5. This is because, compared to other interfaces, picture data is less likely to leak outside, and is kept safe. However, according to the USB standard, a protocol of dividing, for example, picture data to transfer the divided data has not been established.

When the display unit 3 provides high resolution, the size of picture data is assumed to be large. Hence, although transmission requires a long time when picture data is transmitted at a time without being divided, other picture data cannot be transmitted during transmission of this data, and processing efficiency is low.

Therefore, in the present embodiment, picture data is divided and transmitted as follows.

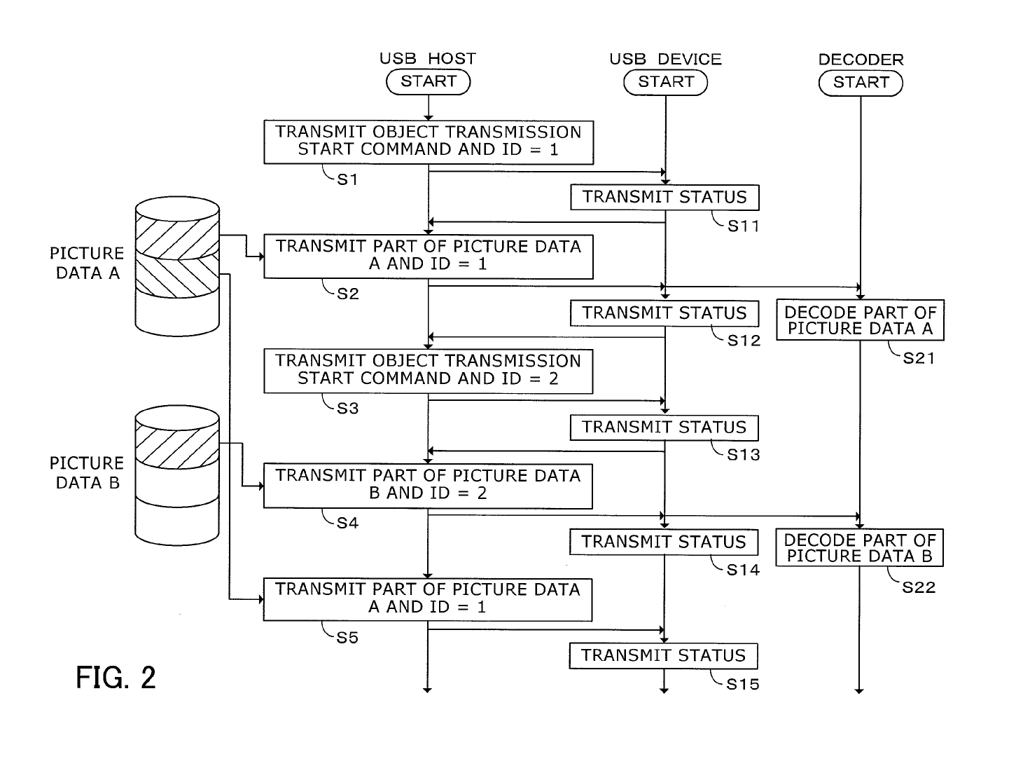

FIG. 2 is a sequence diagram illustrating a processing operation of the display device according to the first embodiment. FIG. 2 illustrates an example where two items of picture data A and B are transmitted from the USB host 16 to the USB device 23 for ease of description.

The USB host 16 allocates a unique ID to each picture data. Meanwhile, the picture data A is allocated ID=1, and the picture data B is allocated ID=2.

First, the USB host 16 transmits an object transmission start command and ID=1 of the picture data A to be transmitted, to the USB device 23 (step S1). When the object transmission start command is received, the USB device 23 returns a status of the USB device. That is, when the USB device is in a status where the USB device 23 can receive data, the USB device 23 returns a status indicating that object data can be received (step S11).

When the status of the USB device 23 has been confirmed, the USB host 16 transmits the picture data A to the USB device 23 (step S2). Here, the USB host 16 divides the picture data A and transmits a part of the picture data together with ID=1, instead of transmitting entirety of the picture data A at a time.

When the part of the picture data A is received, the USB device 23 returns a status indicating that reception is successful (step S12). Further, the decoder 24 decodes the part of the picture data A (step S21).

While the decoder 24 processes the part of the picture data A, the USB host 16 transmits the picture data B to the USB device 23 as follows.

First, the USB host 16 transmits the object transmission start command and ID=2 of the picture data to be transmitted, to the USB device 23 (step S3). When the object transmission start command is received, the USB device 23 returns a status of the USB device. Even while the decoder 24 is decoding the part of the picture data A, the USB device 23 can receive object data. Therefore, the USB device 23 returns a status indicating that object data can be received (step S13).

When the status of the USB device 23 has been confirmed, the USB host 16 transmits the picture data B to the USB device 23 (step S4). Again, the USB host 16 divides the picture data B and transmits a part of the picture data together with ID=2, instead of transmitting entirety of the picture data B at a time.

When the part of the picture data B is received, the USB device 23 returns the status indicating that reception is successful (step S14). The decoder 24 can decode another picture data B even while decoding the picture data A. Therefore, the decoder 24 decodes the part of the picture data B (step S22).

Subsequently, the USB host 16 transmits a part (or entirety) of an untransmitted portion of the picture data A together with ID=1 of the picture data to the USB device 23 (step S5). When the picture data A is received, the USB device 23 returns the status indicating that reception is successful (step S15). The USB device 23 can recognize that the transmitted data is a part (or entirety) of the picture data A, a part of which was previously transmitted, based on a fact that ID=1.

Similarly, the rest of portions of the picture data A and B are subsequently transferred. Note that, how to divide the picture data A and B, in what order or at what timing the portions of the picture data A and B are transferred are determined in advance, taking into account a transfer rate between the USB host 16 and the USB device 23 and a processing speed of the decoder 24.

As stated above, in the first embodiment, a different ID is allocated to each item of the picture data, and the picture data is divided and transmitted. Consequently, before transmission of one of the picture data is completed, transmission of the other picture data can be started. As a result, it is possible to efficiently transfer object data. Further, it is also possible to transmit a part of the picture data B to the video processing device 2 while transmitting a part of the picture data A to the video processing device 2 and decoding the part of the picture data.

### Second Embodiment

According to a second embodiment described below, what portion of picture data needs to be transmitted from a USB host 16 is requested by a USB device 23.

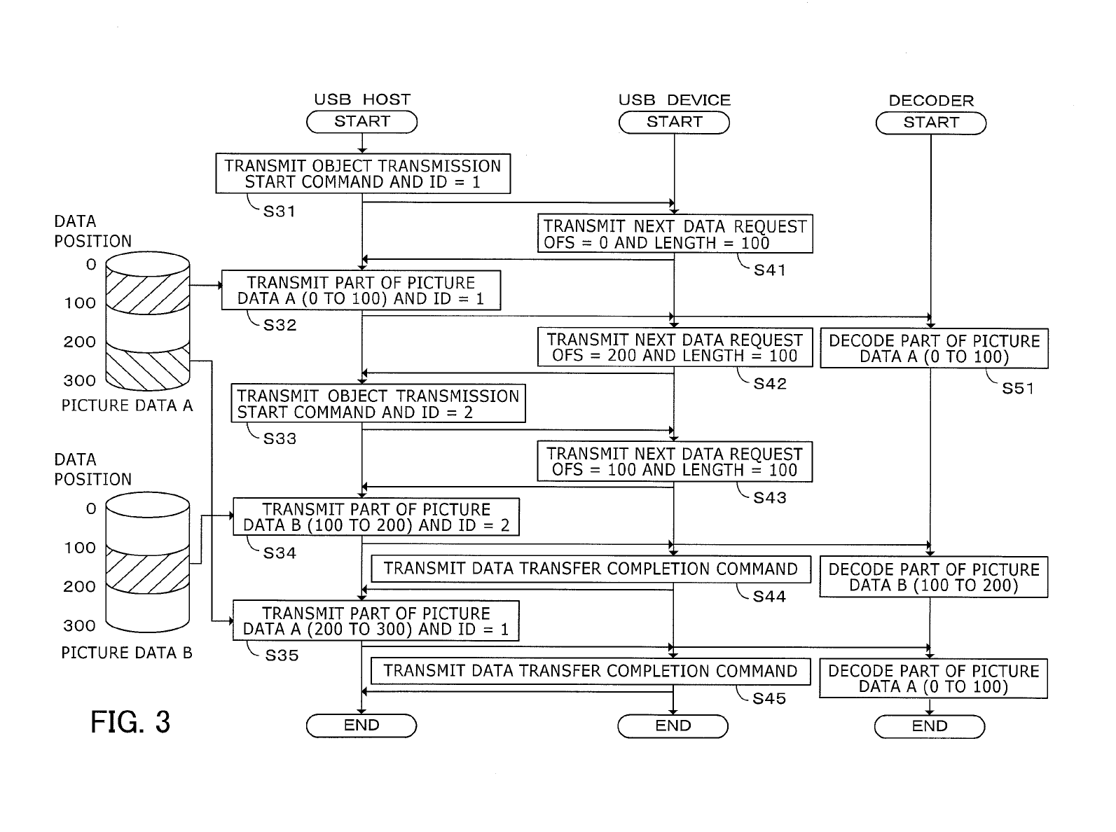

FIG. 3 is a sequence diagram illustrating a processing operation of a display device according to the second embodiment. FIG. 3 illustrates an example where a video processing device 2 (or a decoder 24) requires portions of data positions 0 to 100 and data positions 200 to 300 of picture data A and portions of data positions 100 to 200 of picture data B, and does not require other portions. What portion is required may be determined in advance or may be notified from the video processing device 2 to the main board 1 in advance. In the following description, differences from FIG. 2 will be mainly described.

First, the USB host 16 transmits an object transmission start command and ID=1 corresponding to the picture data A (step S31).

When receiving the object transmission start command, the USB device 23 returns a status including a next data request indicating a portion of the picture data A which the USB host 16 needs to transmit, in other words, the portion of the picture data A which the video processing device 2 requests, (hereinafter, simply referred to “return a next data request”) (step S41). The portion of the picture data A is indicated by, for example, an offset OFS and a data length LENGTH. The offset OFS is a data start position of a request portion which is based on a head of the picture data A. The data length LENGTH is a data length (data size) of a request portion from the data start position.

In order to, for example, request the portions of the data positions 0 to 100 of the picture data A, the USB device 23 returns a next data request in which offset OFS=0 and data length LENGTH=100 are set, to the USB host 16.

According to the offset OFS=0 and data length LENGTH=100, the USB host 16 transmits a specified portion of the picture data A, that is, the portions of the data positions 0 to 100 of the picture data A, to the USB device 23 (step S32). The portions of the data positions 0 to 100 of the transmitted picture data A are decoded by the decoder 24 (step S51).

The decoder 24 requests the portions of the data positions 200 to 300 subsequently to the portions of the data positions 0 to 100 of the picture data A. In other words, the portions of the data positions 100 to 200 of the picture data A are not necessary. Hence, the USB device 23 sets offset OFS=200 and data length LENGTH=100, and returns a next data request (step S42).

Subsequently, the USB host 16 transmits an object transmission start command and ID=2 corresponding to the picture data B (step S33).

The decoder 24 does not require portions from the head of the picture data B to the data position 100, and requires only the data positions 100 to 200. In this case, the USB device 23 sets offset OFS=100 and data length LENGTH=100, and returns a next data request (step S43).

According to these offset OFS=100 and data length LENGTH=100, the USB host 16 transmits a specified portion of the picture data B, that is, the portions of the data positions 100 to 200 of the picture data B, to the USB device 23 (step S34). Further, the USB device 23 transmits a data transfer completion command which indicates that reception of the required portion of the picture data B is completed, to the USB host 16 (step S44). On the other hand, the portions of the data positions 100 to 200 of the transmitted picture data B are decoded by the decoder 24 (step S52).

Subsequently, the USB host 16 transmits the portions of the data positions 200 to 300 of the picture data A to the USB device 23 based on offset OFS=200 and data length LENGTH=100 in step S42 (step S35). Further, the USB device 23 transmits a data transfer completion command which indicates that reception of the required portion of the picture data A is completed, to the USB host 16 (step S45). On the other hand, the portions of the data positions 200 to 300 of the transmitted picture data A are decoded by the decoder 24 (step S53).

Picture data may include, in addition to the image data to be displayed, data which does not need to be displayed, such as an image capturing date and time of a photo and an image capturing site. The data which does not need to be displayed is unnecessarily be transferred to and decoded in the video processing device 2. Consequently, by transferring only an image data portion of picture data which is actually necessary, it is possible to suppress a data transfer amount.

The decoder 24 can recognize what data position of picture data is the image data and what data position is the data which does not need to be displayed. Therefore, the decoder 24 may determine a required data position of the picture data, and command the USB device 23 to request the data position.

As stated above, in the second embodiment, what portion of the picture data needs to be transmitted is requested from the USB device 23 to the USB host 16. Consequently, it is possible to suppress a data transfer amount from the USB device 23 to the USB host 16.

### Third Embodiment

According to a third embodiment described below, a USB device 23 further returns a status indicating that a decoder 24 is in processing.

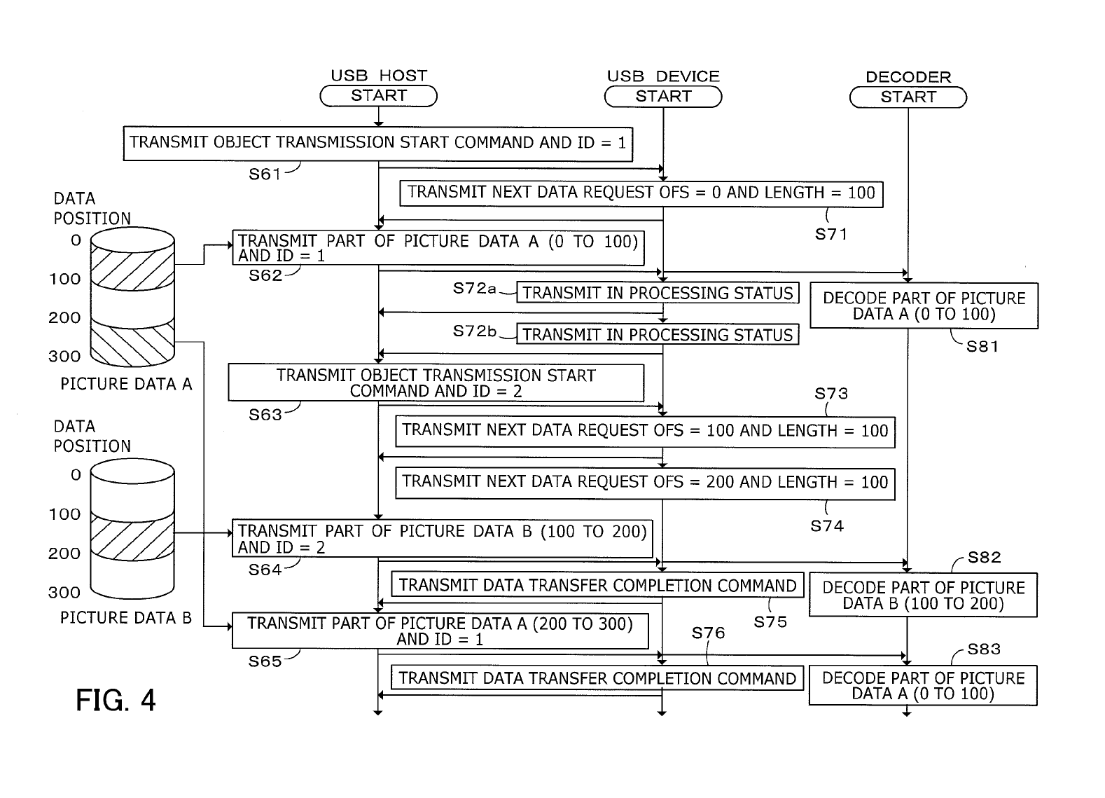

FIG. 4 is a sequence diagram illustrating a processing operation of a display device according to the third embodiment. In the following description, differences from FIG. 3 will be mainly described.

Steps S61, S71, S62 and S81 in FIG. 4 are the same as steps S31, S41, S32 and S51 in FIG. 3, respectively. When portions of data positions 0 to 100 of picture data A are received, the USB device 23 returns a status indicating “in processing” to a USB host 16 (steps S72a and 72b). This “in processing” command indicates that a bus between the USB host 16 and the USB device 23 has been released, and data can be transmitted from the USB host 16 to the USB device 23.

By receiving the “in processing” command, the USB host 16 knows that the bus has been released. Here, since a part of the picture data A is decoded by the decoder 24, the USB host 16 transmits, not the picture data A, but the picture data B. That is, the USB host 16 transmits an object transmission start command and ID=2 corresponding to the picture data B (step S63).

When an object transmission start command is received, the USB device 23 returns a next data request including information which indicates a portion of the picture data B which the USB host 16 needs to transmit (step S73). Here, to request the data positions 100 to 200 of the picture data B, offset OFS=100 and data length LENGTH=100 are set. Further, to request data positions 200 to 300 of the picture data A, a USB device 3 sets offset OFS=200 and data length LENGTH=100, and returns a next data request (step S74).

The subsequent steps are the same as the steps subsequent to step S34 in FIG. 2.

As stated above, according to the third embodiment, when data from the USB host 16 is received, the USB device 23 returns the “in processing” status to the USB host 16 in order to prevent a bus occupied status from continuing. Consequently, the bus is released and it is possible to transmit an object from the USB host 16 to the USB device 23.

The above first to third embodiments are particularly useful when, for example, a display device has a “picture display mode” in which a plurality of items of picture data are displaying by turns. When the picture display mode is set, a plurality of items of picture data are displayed in a thumbnail format. When a user selects one of the items of picture data, the selected picture data is transferred from the USB host 16 to the USB device 23 and is largely displayed on the display unit 3. Here, the picture data selected by the user can be the picture data A in each of the above embodiments.

Further, picture data which is predicted to be selected by the user next can be the picture data B in each of the above embodiments. While the picture data A is divided and transferred from the USB host 16 to the USB device 23, a part of the picture data B is also transferred and decoded while the picture data A is decoded. Consequently, when the user selects the picture data next as predicted, it is possible to display the next selected picture data on the display unit 3 in a short time because the picture data B has already been transferred and decoded.

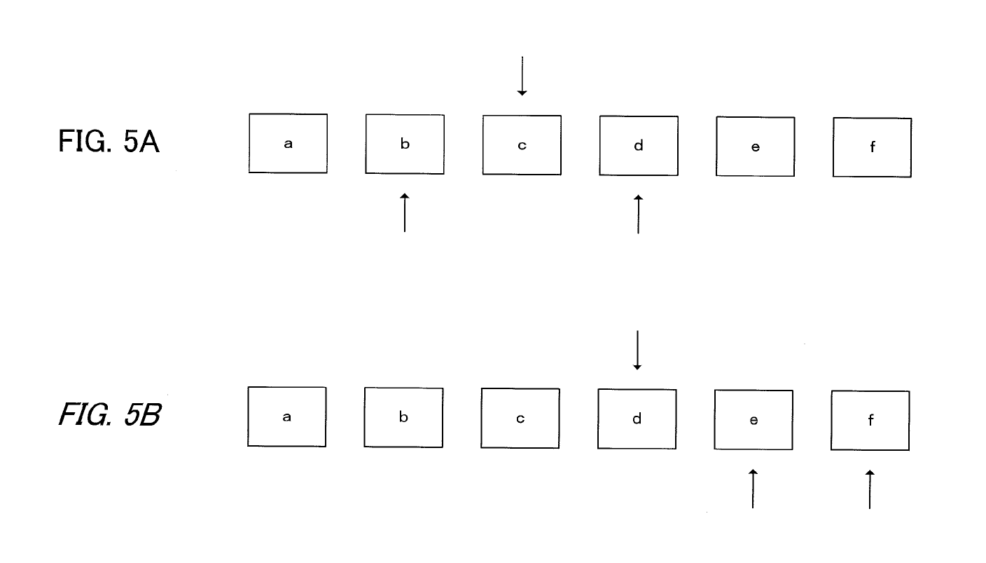

FIGS. 5A and 5B are diagrams illustrating an example of processing of the display device in the picture display mode. FIGS. 5A and 5B schematically illustrate picture data a to f, and image capturing dates and time are older in the order from the picture data a to f.

As illustrated in FIG. 5A, it is assumed that the user first selects a picture data c. In this case, picture data which is predicted to be selected next is picture data having an image capturing date and time preceding or following those of the picture data c, more specifically, data picture data b or picture data d. Therefore, while dividing and transferring the picture data c from the USB host 16 to the USB device 23, the picture data b or the picture data d is transmitted.

As illustrated in FIG. 5B, when the user selects the picture data d having an older image capturing date and time subsequent to the picture data c, picture data which is predicted to be selected next is picture data having an older image capturing date and time than that of the picture data d and, more specifically, picture data e. Therefore, while dividing and transferring the picture data d from the USB host 16 to the USB device 23, the picture data e (moreover picture data f, in some cases) is transmitted. Alternatively, the picture data c may be selected again, and therefore the picture data c may be transferred or the picture data c may be stored in a video processing device 2.

Picture data which is predicted to be selected next may also be specified based on a file name and/or an updated date and time of data besides an image capturing date and time.

Further, in the above embodiments, although an example where picture data is transferred, other object data may be transferred.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. A display comprising:
a USB host configured to divide object data, and to transmit the divided object data and a unique ID allocated to the object data through a USB cable;
a USB device configured to receive the object data from the USB host through the USB cable; and
a display unit configured to display an image corresponding to the object data.

2. The display of claim 1, wherein, after transmitting a part of first object data and a unique ID allocated to the first object data and before completing transmission of entirety of the first object data, the USB host is configured to transmit a part of second object data and a unique ID allocated to the second object data.

3. The display of claim 1 further comprising a processor configured to process the object data,
wherein the display unit is configured to display the image corresponding to the processed object data.

4. The display of claim 3, wherein the processor is configured to start processing the divided object data before entirety of the object data is received.

5. The display of claim 4, wherein the processor is configured to process a part of second object data while processing a part of first object data.

6. The display of claim 3, wherein the object data is compressed picture data; and
the processor is configured to decode the compressed picture data.

7. The display of claim 1, wherein:
the USB host is configured to transmit the ID and an object transmission start command to the USB device;
the USB device is configured to, according to the object transmission start command, return a status to the USB host, the status indicating that the USB device can receive the object; and
the USB host is configured to, according to the status, transmit the ID and the divided object data to the USB device.

8. The display of claim 1, wherein the USB device is configured to request what portion of the object data the USB host needs to transmit, to the USB host.

9. The display of claim 8, wherein the USB device is configured to request what portion of the object data the USB host needs to transmit, to the USB host by a data start position of a portion of the object data and a data length from the data start position.

10. The display of claim 8, wherein the USB device is configured to request a portion of the object data which is required to be displayed on the display unit.

11. The display of claim 1, wherein, when a part of the object data is received, the USB device is configured to return a status indicating that a bus from the USB host to the USB device has been released.

12. The display of claim 1, wherein, after transmitting a part of first object data among a plurality of items of object data to the USB device, the USB host is configured to transmit a part of second object data which is predicted to be selected next to the first object data, to the USB device.

13. A USB host configured to divide object data, and to transmit the divided object data and a unique ID allocated to the object data through a USB cable.
